(19) United States
(12) Patent Application Publication
(10) Pub. No.: US 2013/0295293 A1
(43) Pub. Date: Nov. 7, 2013

(54) COATING COMPOSITION FOR CREATING PROTECTIVE LAYER OVER SOLID SURFACES

(71) Applicant: SUPER-FLEX, LLC, Lakewood, CO (US)

(72) Inventors: Dennis Lowrie, Lakewood, CO (US); Robert G. Blahnik, Denver, CO (US)

(73) Assignee: SUPER-FLEX, LLC, Lakewood, CO (US)

(21) Appl. No.: 13/836,249

(22) Filed: Mar. 15, 2013

Related U.S. Application Data
(60) Provisional application No. 61/643,451, filed on May 7, 2012.

(51) Int. Cl. C09D 133/00

(52) U.S. Cl. CPC C09D 133/00
USPC 427/427.4; 524/522; 524/523

(57) ABSTRACT

A coating composition configured to create a thin, durable, elastic, protective outer layer over a solid surface, where the coating includes an acrylic copolymer and an acrylic resin. The coating renders the solid surface more resistant to deterioration and defacement such as due to weather-related events, chemical reactions, and graffiti.

### CROSS REFERENCE TO RELATED APPLICATIONS

This application claims priority from U.S. Provisional Patent Application No. 61/643,451, entitled “Coating Composition for Imparting Anti-Graffiti Properties to Solid Surfaces,” and filed on May 7, 2012, the entire contents of which are incorporated herein as if set forth in full.

### FIELD OF THE INVENTION

This invention generally relates to chemical mixtures for imparting properties to solids surfaces and, more particularly, to a coating composition that may be used to create and provide a thin, durable, flexible protective layer over solid surfaces such as walls, bridges, automobiles, and the like to render the solid surfaces resistant to weather-related damage, chemical changes, marring, graffiti, and the like.

### BACKGROUND OF THE INVENTION

Exterior surfaces (e.g., surfaces exposed to the environment) of structures such as building walls, bridges, and the like are often subject to damage and/or deterioration due to a variety of causes. For instance, the exterior surfaces of metallic (e.g., iron) bridges or railroad cars can oxidize in the presence of water, oxygen and/or salt leading to rusting and corrosion of the bridges over time. As another example, the exterior surfaces of houses can fade in color, peel, warp, become pitted, etc. over time due to weather-related events such as wind-storms, hail, rain, and the like. Still further, some exterior surfaces exposed in public places (e.g., building walls, storage tanks, railroad cars, bridges, etc.)

are sometimes defaced and/or vandalized with spray paint or other marking materials by graffiti artists, gang members, and the like. The time, expense and effort involved in restoring such exterior surfaces are often substantial.

One solution to resisting such damage and/or deterioration is to apply one or more coatings (e.g., paint, lacquer, varnish) that attempt to isolate the exterior surfaces from the environment or reduce the adhesion of the cured material (e.g., spray paint) such that it is relatively easily removed from the surface at a later time (e.g., pressure washing, wiping with solvents, etc.). However, currently available exterior surface coatings suffer from a number of drawbacks such as short shelf and/or pot life, low levels of adhesion, reduced flexibility, long cure times, increased labor due to the need to separately apply multiple components, and the like.

### SUMMARY OF THE INVENTION

Disclosed herein is a coating composition that may be applied in any appropriate manner (e.g., spraying, brushing, rolling, etc.) to a solid (e.g., exterior) surface or substrate (e.g., concrete, brick, metal, wood, glass, paper, plastic, etc.) to create a thin, durable, flexible protective outer layer or coating on the solid surface that isolates the surface from environmental damage and limits the occurrence of chemical reactions on the surface (e.g., oxidation leading to rusting and corrosion). Furthermore, application of the disclosed coating composition to a solid surface may create a high chemical resistance against adherence of spray paint coatings and other marking materials (e.g., paints, inks, etc.) to the solid surface to facilitate removal of the same from the outer protective layer over the solid surface (e.g., via spraying with water, wiping with any appropriate cleaning solvent, and the like). The various components of the coating composition may be combined in any appropriate blending apparatus or vessel (e.g., low sheer mixer) and then properly stored for long periods of time (e.g., 2-4 years) in a “ready to use” formula (i.e., the components of the disclosed coating compositions need not necessarily be combined just before use).

In one aspect, the disclosed coating composition includes the combination of at least a first component (e.g., first ingredient) in the form of an acrylic copolymer being present in the composition at least in the amount of approximately 90 wt % and a second component (e.g., second ingredient) in the form of an acrylic resin being present in the composition at least in the amount of approximately 0.2 wt %. Broadly, the acrylic copolymer imparts a number of benefits to the resulting composition such as hydrophobicity (water resistance), increased durability, increased adhesion properties, compatibility with other formulating ingredients, and the like. Furthermore, addition of the acrylic resin to the acrylic copolymer serves to both enhance existing properties of as well as introduce additional benefits to the acrylic copolymer such as by promoting wet and dry adhesion, improving resistance to solvents, impacts, marring, and staining for wood, plastics, etc., increasing durability, and/or the like.

In one embodiment, the acrylic copolymer may be selected from at least one of a styrene acrylic and a styrenated acrylic latex. In another embodiment, the acrylic resin may include a silane, such as an organosilane ester and/or a cycloaliphatic epoxy ester.

The resulting coating composition may be applied (e.g., sprayed) over a solid surface to create an extremely durable, thin, clear, long-lasting protective coating or layer over or on the solid surface that is highly resistant to chemical reactions (e.g., corrosion), marring, weather, and the like. Furthermore, it has been found that combining the acrylic copolymer and the acrylic resin in the manners disclosed herein (e.g., at least about 90 wt % of the acrylic copolymer and at least about 0.2 wt % of the acrylic resin) unexpectedly imparts a plurality of additional and/or enhanced benefits to the resulting coating composition (i.e., benefits above and beyond any those introduced to the coating composition by the acrylic copolymer and the acrylic resin individually) such as increased adherence to a wider range of surfaces (e.g., glass, wood, metal, etc.), increased durability (e.g., increased stretchability and flexibility), increased clarity, increased sprayability, increased ability to resist various types of acids (e.g., sulfuric, nitric), increased resistance to flames, increased resistance to dry scraping, increased resistance to water, and increased resistance to particulate abrasion (e.g., sand blasting).

In some approaches, additional components/ingredients may be added to the coating composition to impart additional/enhanced benefits/features to the composition. In one arrangement, any appropriate ultraviolet (UV) light absorber may be added (e.g., Flexisorb™ AQ-50, by Innovative Chemical Technologies, Inc. of Cartersville, GA) to the composition to impart UV protection to the composition and thus to the surface over which the composition is applied. In another arrangement, any appropriate component that is configured to slow down the drying time of the composition to allow the composition to self-level before setting (e.g., during brushing and/or spraying) may be added to the composition (e.g., a dipropylene glycol monobutyl ether, such as Glycol Ether DPM as supplied by Cisco Caroline International Sales Co., Inc. of Matthews, N.C.). In a further arrangement, any appropriate flattening agent may be added to the coating composition to obtain a desired glossiness of the composition.

In another aspect, the first component (e.g., first ingredient) of the coating composition may be in the form of acrylic copolymer solids present in the coating composition at least in the amount of approximately 20 wt %, a second component in the form of acrylic resin solids present in the coating composition at least in the amount of approximately 0.2 wt %; and liquid present in the coating composition at least in the amount of approximately 20%. For instance, the liquid may include at least water and a solvent such as a primary or secondary alcohol (e.g., isopropyl alcohol, ethanol, etc.).

In a further aspect, the first component of the coating composition may be in the form of a leather cleaner and/or conditioner, and the second component may be in the form of an acrylic latex adhesive, e.g., caulking One example of a leather cleaner and conditioner is an interior dressing referred to as “Leather Magic,” sold under the product number “LMG 175” and available from B & B Blending, Inc. of Northglenn, Colo. The second component may be in the form of Polyseamseal® Tub & Tile Adhesive Caulk, sold by Henkel Corporation of Avon, Ohio, and an MSDS describing the same is attached as Exhibit A.

Various refinements may exist of the features noted in relation to the various aspects. Further features may also be incorporated in the various aspects. These refinements and additional features may exist individually or in any combination, and various features of the aspects may be combined. In addition to the exemplary aspects and embodiments described above, further aspects and embodiments will become apparent by reference to the drawings and by study of the following descriptions.

### DETAILED DESCRIPTION

The disclosed coating composition and related utilities (e.g., methods of formulation of the composition, methods of use of the composition) include the combination of at least a first component and a second component, where the resulting composition may be coated over numerous types of solid surfaces (e.g., metal, wood, glass, brick, etc.) in a number of manners (e.g., spraying, painting, rolling, etc.) to form a (e.g., clear) protective coating over the surfaces that resists various types of deterioration of and damage to the surfaces over long periods of time.

In one aspect, the first component may be in the form of an acrylic copolymer and the second component may be in the form of an acrylic resin. The acrylic copolymer may be present in the coating composition at least in the amount of approximately 90 wt % and the acrylic resin may be present in the coating composition at least in the amount of approximately 0.2 wt %.

In one arrangement, the acrylic copolymer may be present in the coating composition at least in the amount of approximately 92 wt %, such as at least approximately 94 wt %, or at least approximately 95 wt %. In another arrangement, the acrylic copolymer may be present in the coating composition in the amount of not more than approximately 98 wt %, such as not more than approximately 97 wt %, or not more than approximately 96 wt %. In another arrangement, the acrylic resin may be present in the coating composition at least in the amount of approximately 0.5 wt %, such as at least approximately 0.8 wt %, or 1 wt %. In another arrangement, the acrylic resin may be present in the coating composition in the amount of not more than approximately 2 wt %, such as not more than approximately 1.5 wt %, or 1.2 wt %.

Characterized a different way, the acrylic copolymer and acrylic resin may be present in the coating composition in the ratio of at least approximately 30/1 (i.e., the ratio of the first component to the second component), such as at least approximately 40/1, and in one variation at least approximately 50/1. Further characterized differently, the first and second components may be present in the combination in the ratio of no more than approximately 450/1, such as no more than approximately 250/1, and in one variation no more than approximately 100/1. In one specific arrangement, the acrylic copolymer and acrylic resin may be present in the coating composition in the ratio of approximately 96/1.

The acrylic copolymer may include solids at least in the amount of approximately 20 wt %, such as at least in the amount of approximately 40 wt %. Additionally or alternatively the acrylic copolymer may include solids in the amount of not greater than approximately 80 wt %, such as not greater than approximately 75 wt %, or even 70 wt %. The acrylic copolymer may include liquids at least in the amount of approximately 15 wt %, such as at least in the amount of 25 wt %, or even 35 wt %. In another variation, the acrylic copolymer may include liquids in the amount of not greater than approximately 80 wt %, such as not greater than approximately 70 wt %, or 60 wt %. In one embodiment, the liquids in the acrylic copolymer may include water and at least one solvent (e.g., primary or secondary alcohols such as isopropyl alcohol, ethanol, etc.), where the solvent is present in the liquids at least in the amount of approximately 1 wt %, such as at least in the amount of 2 wt %, or even 3 wt %. In another embodiment, the solvent may be present in the liquids in the amount of not greater than approximately 10 wt %, such as not greater than approximately 8 wt %, or 6 wt %.

The acrylic copolymer may in some arrangements include at least one of a styrene acrylic and a styrenated acrylic latex. Examples of an acrylic copolymer are Synthebond® E 6090 supplied by Momentive of Columbus, Ohio; Acronal Optive® 310, supplied by BASF Corporation of Florham Park, N.J.; NAS® 21, supplied by INEOS NOVA of Fribourg, Switzerland; Savinex 7101, 7102, or 7103, supplied by The Synthetic Latex Company of Bruma, South Africa; Rovene® 6066, supplied by Mallard Creek Polymers, Inc. of Charlotte, N.C.; and the like.

In one arrangement, the acrylic resin may include a silane, such as an organosilane ester and/or a cycloaliphatic epoxy ester. Examples of acrylic resins include CoatOSil® 1770 supplied by Momentive of Columbus, Ohio; AP Silane 33W, supplied by Advance Polymer, Inc. of Carlstadt, N.J.; E6250 or G6720, supplied by UCT, Inc. of Bristol, Pa.; SiSiB® PC3510, SiSiB® PC 3500, or SiSiB® PC 3300, supplied by Power Chemical Corporation of Nanjing, China; and the like.

In some arrangements, additional components/ingredients may be added to the coating composition to impart additional/enhanced benefits/features to the composition. In one approach, any appropriate UV absorber may be added to the composition to impart UV protection to the composition and thus to the surface over which the composition is applied. Representative UV absorbers may include a benzotriazole such as Flexisorb™ AQ-50, by Innovative Chemical Technologies, Inc. of Cartersville, Ga.; or Lowilite® 24 or Lowilite® 26, supplied by Chemtura Corporation of Middlebury, Conn.; a benzophenone such as Chimassorb® 81, supplied by BASF, The Chemical Company, of Basel, Switzerland; Hostavin® 3050 and Hostavin® 3041, supplied by Clariant Corporation of Charlotte, N.C.; Cyasorb® UV-1164 L, supplied by Cytec Industries Inc. of Woodland Park, N.J.; and/or the like.

For instance, the UV light absorber may be present in the coating composition at least in the amount of approximately 0.2 wt %, such as at least approximately 0.5 wt %, or 1 wt %. As another example, the UV light absorber may be present in the coating composition in the amount of not more than approximately 5 wt %, such as not more than approximately 4 wt %, or 3 wt %. As a further example, the acrylic resin and the UV light absorber may be present in the coating composition in the ratio of approximately 1/1.

In another approach, any appropriate component that is configured to slow down the drying time of the composition to allow the composition to self-level before setting (e.g., during brushing and/or spraying) may be added to the composition; representative examples may include at least one glycol ether such as a dipropylene glycol monobutyl ether named Glycol Ether DPM as supplied by Cisco Carolina International Sales Co., Inc. of Matthews, N.C.; a propylene glycol n-butyl ether (PnB), Chemical Abstracts Service (CAS) No. 29387-86-8 (5131-66-8); a dipropylene glycol n-butyl ether (DPnB), CAS No. 29911-28-2 (35884-42-5); a dipropylene glycol methyl ether acetate (DPMA), CAS No 88917-22-0; a tripropylene glycol methyl ether (TPM), CAS No. 25498-49-1 & 20324-33-8; a propylene glycol methyl ether (PM), CAS No. 107-98-2; a propylene glycol methyl ether acetate (PMA), CAS No. 108-65-6; a dipropylene glycol methyl ether, CAS No. 34590-94-8; and/or the like.

For instance, the glycol ether may be present in the coating composition at least in the amount of approximately 0.5 wt %, such as at least approximately 1 wt % or 1.5 wt %. As another example, the glycol ether may be present in the coating composition in the amount of not more than approximately 3 wt %, such as not more than approximately 2.5 wt %, or 2 wt %. As further examples, the acrylic resin and the glycol ether may be present in the coating composition in the ratio of approximately 1/2 and/or the UV light absorber and the glycol ether may be present in the coating composition in the ratio of approximately 1/2.

In another aspect, the first component may be in the form of a leather cleaner and/or conditioner and the second component may be in the form of an acrylic latex adhesive (e.g., caulking) In one embodiment, the leather cleaner and/or conditioner may be present in the disclosed combination at least in the amount of approximately 50 wt %, such as at least in the amount of approximately 51 wt %, and in one variation at least in the amount of approximately 52 wt %. In another embodiment, the leather cleaner and/or conditioner may be present in the disclosed combination at no more than the amount of approximately 55 wt %, such as no more than the amount of approximately 54 wt %, and in one variation no more than the amount of approximately 53 wt %.

In another embodiment, the acrylic latex adhesive may be present in the disclosed combination at least in the amount of approximately 45 wt %, such as at least in the amount of approximately 46 wt %, and in one variation at least in the amount of approximately 47 wt %. In another embodiment, the acrylic latex adhesive may be present in the disclosed combination at no more than the amount of approximately 50 wt %, such as no more than the amount of approximately 49 wt %, and in one variation no more than the amount of approximately 48 wt %.

Characterized a different way, the leather cleaner and/or conditioner (i.e., the first component), and the acrylic latex adhesive (i.e., the second component) may be present in the combination in the ratio of at least approximately 1/1 (i.e., the ratio of the first component to the second component), such as at least approximately 51/49, and in one variation at least approximately 52/48. Further characterized differently, the first and second components may be present in the combination in the ratio of no more than approximately 55/45, such as no more than approximately 54/46, and in one variation no more than approximately 53/47.

In a further embodiment of this aspect, additional components may be added to the first component (i.e., leather cleaner and/or conditioner) and the second component (i.e., the acrylic latex adhesive caulking) to impart one or more additional benefits/advantages to the resulting coating composition. For instance, a third component in the form of an exterior construction adhesive may be added to the coating composition in any appropriate amount to further resist abrasion and maintain flexibility of the coating composition (e.g., such as Power Grab®, Instant Grab™ Heavy Duty Exterior Construction Adhesive, sold by Henkel Corporation of Avon, Ohio). Additionally or alternatively, a fourth component in the form of an interior construction adhesive may be added to the coating composition to further reduce tackiness (e.g., for non-porous surfaces) and facilitate curing/dry time of the coating composition (e.g., such as Power Grab®, Instant Grab™ All Purpose Interior Construction Adhesive, sold by Henkel Corporation of Avon, Ohio).

In one approach of this aspect, the first component (i.e., leather cleaner/conditioner) may be present in the disclosed combination at least in the amount of approximately 63 wt %, such as at least in the amount of approximately 64 wt %, and in one variation at least in the amount of approximately 65 wt %. In another embodiment, the first component may be present in the disclosed combination at no more than the amount of approximately 70 wt %, such as no more than the amount of approximately 69 wt %, and in one variation no more than the amount of approximately 68 wt %.

In another approach, the second component (i.e., the acrylic latex caulking) may be present in the disclosed combination at least in the amount of approximately 10 wt %, such as at least in the amount of approximately 11 wt %, and in one variation at least in the amount of approximately 12 wt %. In another embodiment, the second component may be present in the disclosed combination at no more than the amount of approximately 16 wt %, such as no more than the amount of approximately 15 wt %, and in one variation no more than the amount of approximately 14 wt %.

In another approach, the third component (i.e., the heavy duty exterior construction adhesive) may be present in the disclosed combination at least in the amount of approximately 10 wt %, such as at least in the amount of approximately 11 wt %, and in one variation at least in the amount of approximately 12 wt %. In another embodiment, the second component may be present in the disclosed combination at no more than the amount of approximately 16 wt %, such as no more than the amount of approximately 15 wt %, and in one variation no more than the amount of approximately 14 wt %.

In a further approach, the fourth component (i.e., the all purpose interior construction adhesive) may be present in the disclosed combination at least in the amount of approximately 3 wt %, such as at least in the amount of approximately 4 wt %, and in one variation at least in the amount of approximately 5 wt %. In another embodiment, the second component may be present in the disclosed combination at no more than the amount of approximately 9 wt %, such as no more than the amount of approximately 8 wt %, and in one variation no more than the amount of approximately 7 wt %.

It has been found that the disclosed amounts and/or ratios of the various components of each of the aspects of the disclosed coating composition advantageously facilitates spray application of the coating composition over numerous types of solid surfaces to create protective coatings over the same. Specifically, it has been found that the disclosed amounts and/or ratios allow the coating to be sprayed onto a solid surface even in windy conditions and without or at least with only limited amounts of dripping. The coating composition may also be applied to solid surfaces in other manners such as by painting, rolling, etc.

Once the disclosed coating has been prepared and appropriately applied to a solid surface or substrate to create a thin, protective, durable, rubber-like outer layer or film on the surface, the surface becomes more resistant to damage and deterioration over time. For instance, the coating has been shown to be resistant to various types of acids (e.g., sulfuric, nitric), caustic soda (e.g., sodium hydroxide), sand blasting, UV light, oxygen, moisture (e.g., which may otherwise lead to oxidation of the underlying solid surface; peeling, warping, or fading of the underlying surface), and/or the like. As a further example, spray paint and/or other marking material (e.g., graffiti) applied over the protective outer layer may be removed more easily from the protective outer layer than directly from the solid surface itself.

In one arrangement, any appropriate solvent (e.g., d-limonene or Orange Terpenes, toluene, etc.) may be used to remove the graffiti from the outer protective layer and thus from the solid surface. Such solvent may be wiped over the graffiti (e.g., with a rag, brush, etc.), sprayed over the graffiti (e.g., with a hose), and/or the like until the graffiti has been removed. In another arrangement, plain water may be used (e.g., via spraying, wiping, etc.) to remove the graffiti/marking from the outer protective layer and thus from the solid surface. Other manners of removing the graffiti/marking are also envisioned. For instance, sand-blasting could be utilized to remove the graffiti/marking from the outer protective layer substantially free of damaging the underlying surface. In the event it is determined that the outer protective layer on the solid surface is failing to adequately protect the surface from damage or deterioration and/or failing to allow graffiti to be removed from the solid surface, the coating composition can be reapplied to the solid surface as necessary to “recharge” the outer protective layer. In some arrangements, the disclosed coating composition may be added in any appropriate amount or ratio to a water-based paint (e.g., latex or acrylic) or an oil-based paint.

### Example

A coating composition was prepared by combining approximately 9.60 lbs of Synthebond® E 6090 (Momentive of Columbus, Ohio), approximately 0.1 lbs of

CoatOSil® 1770 (Momentive of Columbus, Ohio), approximately 0.1 lbs of Flexisorb™ AQ-50 (Innovative Chemical Technologies, Inc. of Cartersville, Ga.), and approximately 0.2 lbs of Glycol Ether DPM (Cisco Carolina International Sales Co., Inc. of Matthews, N.C.). The Synthebond® E 6090 was placed in a low sheer mixer and laminar stirring was initiated at between about 300 RPM to 600 RPM at room temperature. The Glycol Ether DPM was then added to the mixer and stirring proceeded for about 10-20 minutes. The Flexisorb™ was then added and stirring proceeded for another approximately 10 minutes. The CoatOSil® 1770 was then added and stirring proceeded for another approximately 10-20 minutes (e.g., to enhance batch homogeneity).

The resulting coating composition was then applied to numerous types of surfaces (e.g., wood, metal, paper, etc.) in various manners (e.g., brushing, spraying, dripping, etc.) and subjected to various types of tests, the specific tests and results thereof being described below:

1) Sand Blasting:

The coating composition was added to an empty airless paint sprayer having a tip size of 5.17 and three layers of the coating were sprayed over various samples/substrates of metal, cinder block, wood, asphalt shingle, plastic bucket, and card board at a rate of about 800 ft²/gal. Each layer was allowed to dry for approximately 5 min and had a thickness of approximately 1/200 of an inch. The resulting coating had a density of approximately 8.7 lb/gal. A sand blasting nozzle including 80 grit beads was then positioned approximately 1-2 feet away from each of the foregoing samples and operated at a pressure of about 100 psi for about 30 seconds. The coating composition protected each of the samples from damage.

2) Acid:

A single layer of the coating composition was brushed over a coffee filter and a piece of rusty metal and allowed to dry for 24 hours. The room was at 20° C. and 50% relative humidity. Three drops of sulfuric acid (95%-98% concentration) were applied over the same location on the coating composition on the coffee filter and piece of rusty metal. The sulfuric acid continued to remain in a puddle for several hours free of damaging the coffee filter or the piece of rusty metal (e.g., no holes or other such damage).

Three single layers were brushed over the inside and the outside of a paper paint strainer and allowed to dry for 24 hours. The room was at 20° C. and 50% relative humidity. Ten drops of sulfuric acid (95%-98% concentration) were then dispensed (e.g., drop by drop) around the coating composition on the paper paint strainer. After one hour, the sulfuric acid was sitting at the bottom of the paper strainer. Two ounces of water was then poured into the strainer so as to mix with the sulfuric acid to determine whether the coating composition had prevented or at least resisted damage to the paper paint strainer.

Several weeks later, the water still had not leaked through the bottom of the paper paint strainer. It is noted that additional water had to be continually added to account for evaporation.

A single layer of the coating composition was brushed over a coffee filter and allowed to dry for 24 hours. The room was at 20° C. and 50% relative humidity. Three drops of nitric acid (full strength) were applied over the same location on the coating composition on the coffee filter. The nitric acid continued to remain in a puddle for several hours free of damaging the coffee filter (e.g., no holes or other such damage).

3) Caustic Soda:

A single layer of the coating composition was brushed over a coffee filter and allowed to dry for 24 hours. The room was at 20° C. and 50% relative humidity. Three drops of caustic soda (full strength) were applied over the same location on the coating composition on the coffee filter. The caustic soda continued to remain in a puddle for several hours free of damaging the coffee filter (e.g., no holes or other such damage).

4) Folding and Creasing:

Three single layers were brushed over a paper plate and a piece of typing paper and allowed to dry for 24 hours. The room was at 20° C. and 50% relative humidity. The samples were then bent, folded, and creased, several times, both ways and back and forth. The coating composition did not show any signs of chipping, peeling, blistering, or flaking in the creased areas.

5) Scraping:

A single layer of the coating composition was brushed over pieces of glass and metal and allowed to dry for four hours. The room was at 20° C. and 50% relative humidity. Each piece was then scraped with a new razor blade. It required five attempts to completely remove the coating composition from both of the pieces.

6) Stretch:

A small amount of the coating composition was poured onto a non-stick baking sheet and allowed to dry for 24 hours. The room was at 20° C. and 50% relative humidity. The cured piece of coating was 3 inches by 4.5 inches with a thickness of one-tenth of a centimeter. A pair of vice grips at about 12 lbs of resistance were attached to opposing ends of the cured sample of the coating and pulled in opposite directions for 15 seconds after which the cured sample had stretched about three times its original length. Upon release, the stretched sample returned to its original size within five minutes with a room temperature of 22° C.

7) Flexibility:

After the stretched sample had returned to its original size, the sample was tightly rolled lengthwise and compressed with ten pounds of pressure for five minutes. Upon release, the rolled and compressed cured sample returned to its original size within ten minutes at a room temperature of 22° C.

8) Pierce:

After the rolled and compressed sample had returned to its original size, vice grips were used to hold a pencil and exert (about 10 pounds of force) the eraser end of the pencil against the cured sample in an attempt to pierce through the sample; the eraser end of the pencil caused about a one inch bulge in the sample without piercing through the sample.

9) Flame:

Three single layers were brushed over a paper plate and allowed to dry for 24 hours. The room was at 20° C. and 50% relative humidity. The coated side of the paper plate was then positioned horizontally and a 1½ inch flame from a butane lighter was spaced about 1-2 inches away from the coated side. After about 60 seconds, the coating had softened and became an amber color. The paper plate was not affected by the flame.

10) Adhesive:

A small amount of the coating composition was poured inside the lid and around the threads of a plastic container. The lid was then screwed onto the container and the coating composition was allowed to dry for four hours. The room was at 20° C. and 50% relative humidity. After four hours, attempts were made to remove the lid using rubber grippers; all attempts failed. The lid was eventually removed by locking the container in a vise and using a heavy duty pipe wrench to release the adhesive grip formed by the coating composition.

The foregoing description of the present invention is not intended to limit the invention to the form disclosed herein. Consequently, variations and modifications commensurate with the above teachings, and skill and knowledge of the relevant art, are within the scope of the present invention (such as one or more combinations of the various arrangements, embodiments and approaches disclosed herein). For instance, it is envisioned that the disclosed coating composition could be added in any appropriate amounts to latex paints to impart the disclosed anti-graffiti properties to a solid surface as the same is being painted with the latex paint.

The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A coating composition, comprising:
an acrylic copolymer present in the coating composition at least in the amount of approximately 90 wt %; and
an acrylic resin present in the coating composition at least in the amount of approximately 0.2 wt %, wherein application of the coating composition over a solid surface creates a protective outer layer over the solid surface.

2. The coating composition of claim 1, wherein the acrylic copolymer is present in the coating composition at least in the amount of approximately 92 wt %.

3-4. (canceled)

5. The coating composition of claim 4, wherein the acrylic resin is present in the coating composition at least in the amount of approximately 0.5 wt %.

6. (canceled)

7. The coating composition of claim 1, wherein the acrylic copolymer is present in the coating composition in the amount of not greater than approximately 98%.

8-9. (canceled)

10. The coating composition of claim 1, wherein the acrylic resin is present in the coating composition in the amount of not greater than approximately 2%.

11. (canceled)

12. The coating composition of claim 1, wherein solids are present in the acrylic copolymer at least in the amount of approximately 20 wt %.

13. (canceled)

14. The coating composition of claim 1, wherein liquid is present in the acrylic copolymer at least in the amount of approximately 15 wt %.

15. (canceled)

16. The coating composition of claim 1, wherein liquid is present in the acrylic copolymer in the amount of not greater than approximately 80 wt %.

17. (canceled)

18. The coating composition of claim 16, wherein the liquid comprises a solvent, and wherein the solvent is present in the liquid at least in the amount of approximately 1 wt %.

19-21. (canceled)

22. The coating composition of claim 1, wherein solids are present in the acrylic copolymer in the amount of not greater than approximately 80 wt %.

23. (canceled)

24. The coating composition of claim 1, wherein the acrylic copolymer comprises a styrene acrylic.

25-39. (canceled)

40. A method of forming a protective layer over a solid surface, comprising:
applying the coating composition of claim 1 to a solid surface to form a protective outer layer over the solid surface.

41. The method of claim 40, wherein the applying the coating step comprises:
spraying the coating composition to the solid surface.

42-48. (canceled)

49. A coating composition, comprising:
acrylic copolymer solids present in the coating composition at least in the amount of approximately 20 wt %;
acrylic resin solids present in the coating composition at least in the amount of approximately 0.2 wt %; and
liquid present in the coating composition at least in the amount of approximately 20%, wherein application of the coating composition over a solid surface creates a protective outer layer over the solid surface.

50. The coating composition of claim 49, wherein the acrylic copolymer solids are present in the coating composition at least in the amount of approximately 40 wt %.

51. (canceled)

52. The coating composition of claim 49, wherein the acrylic resin solids are present in the coating composition at least in the amount of approximately 0.5 wt %.

53. (canceled)

54. The coating composition of claim 49, wherein the liquid is present in the coating composition at least in the amount of approximately 30 wt %.

55. (canceled)

56. The coating composition of claim 49, wherein the acrylic copolymer solids are present in the coating composition in the amount of not greater than approximately 80 wt %.

57. (canceled)

58. The coating composition of claim 49, wherein the acrylic resin solids are present in the coating composition in the amount of not greater than approximately 2 wt %.

59. (canceled)

60. The coating composition of claim 49, wherein the liquid is present in the coating composition in the amount of not greater than approximately 80 wt %.

61-80. (canceled)
